(19) United States
(12) Patent Application Publication
(10) Pub. No.: US 2010/0028844 A1
(43) Pub. Date: Feb. 4, 2010

(54) METHOD FOR TRANSFORMING AN UNDER-ACHIEVING STUDENT INTO A SUPERIOR STUDENT

(76) Inventor: Daneya L. Wiseman, Highland Village, TX (US)

Correspondence Address: Michael A. O'Neil. P.C., 8150 North Central Expressway, Suite 1150, DALLAS, TX, 75206, US

(21) Appl. No.: 12/510,685

(22) Filed: Jul. 28, 2009

Related U.S. Application Data
(60) Provisional application No. 61/084,529, filed on Jul. 29, 2008.

(51) Int. Cl. G09B 3/00

(52) U.S. Cl. 434/322

(57) ABSTRACT

A method of transforming an under-achieving student into a superior student comprising monitoring the student's grade level in at least one academic course and automatically terminating the student's access to at least one privilege whenever the student's grade level falls below a predetermined level. The method may also be used to reward a student that maintains a grade level above a predetermined threshold.

### CROSS-REFERENCE TO RELATED APPLICATION

Applicant claims priority based on U.S. Provisional Patent Application Ser. No. 61/084,529 filed Jul. 29, 2008, the entire content of which is incorporated herein by reference.

### DESCRIPTION OF THE DRAWINGS

FIG. 1 is a schematic diagram of a method of transforming an under-achieving student into a superior student comprising an embodiment of the present invention; and

FIG. 2 is a flow chart illustrating a method of transforming an under-achieving student into a superior student comprising an embodiment of the present invention.

### DETAILED DESCRIPTION

Of the many rationales for engaging an institution of learning the acquisition of knowledge is typically touted as paramount. In addition to providing benefits such as extra-curricular and social activities, a school's fundamental role is the impartation of knowledge to students.

To determine if the imparted knowledge has been properly learned by the students, schools and colleges typically administer examinations whereupon students are required to recall and apply the acquired knowledge. Typically, the students individually are given a grade based upon an examination and class performance. The grade usually measures the extent of each student's ability in learning, retaining and applying the imparted knowledge. A low grade indicates a student's poor examination and class performance, whereas a high grade indicates a student's satisfactory or even superior examination and class performance.

Because of the proliferation of technology as well as the increase in U.S. economic standards throughout the decades, a majority of students now have access to cellular phones, credit cards, debit cards and a plethora of extra-curricular activities. Such access can divert the students' academic focus and cause distractions which yield failing grades and lower learning retention.

To provide incentives for learning and the maintenance of satisfactory grades, student privileges such as cellular phone usage, credit/debit card usage and/or extra-curricular activities can be denied if the student's grade level deteriorates beyond a certain grade number or grade letter. Once the student increases the grade number or grade letter to a satisfactory level the student is again granted access to the privileges.

Embodiments of the present invention provide a method and system for denying privileges to a student once the student's grade deteriorates beyond a predetermined grade number or grade letter. The student is notified when a current grade approaches a predetermined and preselected grade number or grade letter. If the grade falls below the predetermined and preselected grade number or grade letter student privileges such as but not limited to cellular phone usage, credit/debit card usage and/or extra-curricular activity participation are automatically suspended. Once the grade improves and increases over the preselected and predetermined grade number or grade level, privileges are reinstated and access is granted to student privileges once again.

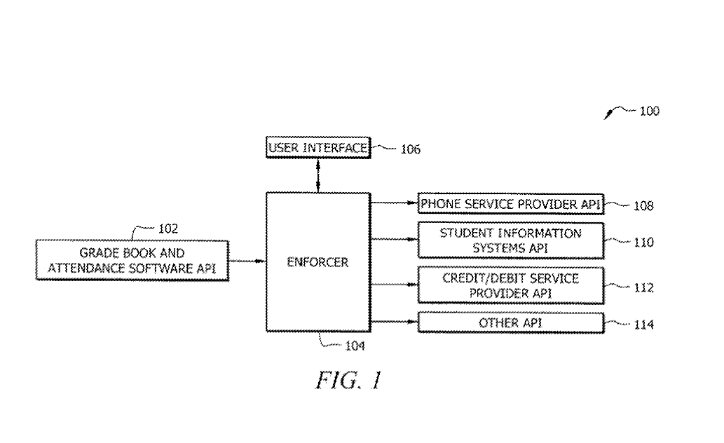

As shown in FIG. 1, an embodiment 100 of the present invention comprises an enforcer 104 which links to an application programming interface (hereinafter “API”) of hardware and/or software devices. A gradebook and attendance software API 102 links to the enforcer 104. The enforcer 104, in turn, non-exclusively and without limitation links to one or more of the following: a phone service provider API 108; student information systems API 110; credit/debit service provider API 112; and/or other API 114. Additionally, the enforcer 104 comprises a user interface 106 for engagement and interactive purposes.

The gradebook and attendance software can comprise one of the many different commercially available software packages for electronic grading. For example, the gradebook and attendance software can comprise one of the following software packages: eSembler™, GradeNetwork, TrackMyGrades, Classbuilder®, or Gradekeeper®. Typically, the gradebook and attendance software package integrates to the student information system within the school district or sub-component thereof.

The gradebook and attendance software such as eSembler™ performs a wide variety of tasks. Such tasks typically include the transfer of grades from the teacher gradebook to district or school information systems, the addition, removal, and management of system users, the identification of student/teacher associations to build class rosters, the importation of course and section information to dynamically populate teacher and student schedules, and the management of additions and drops from course schedules.

Additionally, many software packages such as eSembler™ allow an individual such as a parent or guardian to log into the software via on online browser to view a student's grades. Using eSembler™, for example, a parent or guardian can click on a class name which presents a report detailing the student profile image, parent profile image, student grade averages, student assignment scores, student class averages, student category information and averages, student attendance information, and teacher comments.

The enforcer 104 links to the gradebook and attendance software via the software's application programming interface. For example, eSembler™ creates a series of documented summary tables. The summary tables establish the published applications programming interface for obtaining system information from the eSembler™ database—SQL Server 2005. By linking to the gradebook and attendance software API 102, the enforcer 104 obtains data information that it utilizes for purposes of the embodiments of the present invention.

As mentioned in the foregoing, the enforcer 104 also comprises the user interface 106 for engagement and interactive purposes. Specifically, the user interface 106 comprises a system such as a particular machine, device, computer program or other complex tool. Preferably, the user interface 106 comprises a website and provides means of input wherein the user is allowed to manipulate the system and also provides means of output wherein the system produces the effects of the user's manipulation.

In addition, the user interface 106 comprises means for input, selecting, and displaying information and data to and from an embodiment of the present invention 100. Such means include without limitation a graphical, textual, and/or auditory apparatus and a control sequence such as but not limited to keystrokes with a computer keyboard, movement of a computer mouse, and/or selections with a touchscreen.

Utilizing the user interface 106, a parent or guardian can input information into the enforcer 104. For example, the parent or guardian can input or select a predetermined grade number or grade letter thereby providing a threshold number or letter for the denial of student privileges. Additionally, the parent or guardian can specify the specific student privileges to deny once the student's actual grade number or letter equals and/or decreases below the predetermined and preselected minimum threshold grade number or letter.

Once the predetermined and preselected minimum threshold grade number or letter equals the student's actual grade number or letter and the parent or guardian has specified the specific privileges to deny via the user interface 106, the enforcer 104 communicates the privilege suspension(s) to the privilege provider(s). Therefore, the enforcer 104 receives the data information from the parent or guardian via the user interface 106 as well as the data information from the gradebook and attendance software via the gradebook and attendance software API 102 and transmit data comprising privilege suspension information to various privilege providers.

The privilege providers comprise any person, organization, entity or company that provides goods and/or services to a student. Whether the goods and/or services are provided indirectly to the student are inconsequential in determining whether the good and/or services are privileged. For example, if a parent, guardian, or other individual is listed on the account records of a cellular phone company but the student utilizes the cellular phone with permission from the parent or guardian, the cellular phone company is classified as a privilege provider.

Such privilege providers include but are not limited to phone services, banking and lending services, or extra-curricular activity participation. Therefore, the enforcer 104 links to the phone service providers' API 108, student information systems' API 110, banking/lending services such as credit/debit service providers' API 112 as well as other privilege provider API 114. The enforcer 104 can automatically suspend a student's cellular phone use, a student's attendance at various school sponsored extra-curricular activities, a student's credit or debit card services, or any other activity or service linked thereto. However, if a student's actual grade rises above the predetermined and preselected minimum threshold grade number or letter, the enforcer 104 can automatically reactivate the privilege providers' goods or services for the student.

Of the many embodiments that comprise the present invention, one embodiment envisions the enforcer 104 providing communicative messages to a student, alerting the student if the student's actual grade number or letter decreases to such a degree that it teeters on the brink of falling below the predetermined and preselected minimum threshold grade. In such an embodiment, the enforcer 104 links to the phone service providers' API 108 and communicates to the student via a text message or recorded phone message, notifying the student that if the student's actual grade(s) fall below the pre-determined and pre-selected minimum threshold grade, certain student privileges will be suspended.

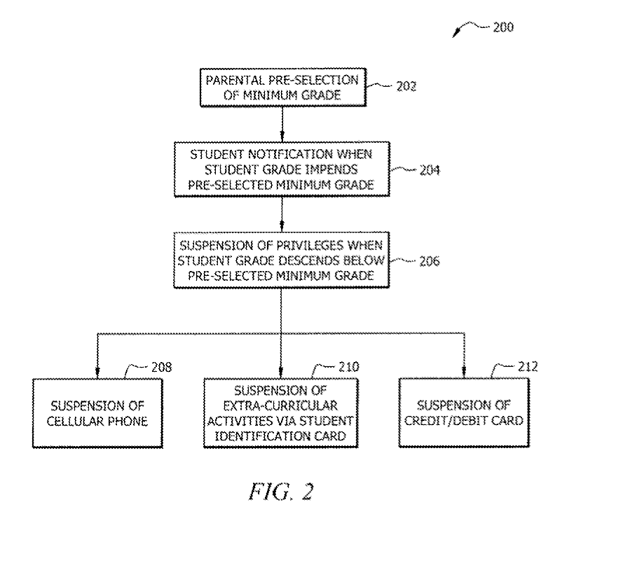

FIG. 2 illustrates an embodiment of the present invention comprising a method 200 for transforming an underachieving student into a superior student. FIG. 2 depicts the method 200 from the user's perspective.

A parent or guardian logs into the enforcer 104 via the user interface 106 and preselects the student's minimum grade 202 for an examination, project, class performance, or overall course grade. The parent or guardian can select a minimum grade for one or more classes. This preselected and predetermined minimum grade number or letter represents a threshold value which the enforcer 104 enforces by suspending and deactivating privilege providers. The parent or guardian also selects the privilege providers that will be suspended and deactivated.

When the student's actual grade number or letter begins to approach the preselected and predetermined grade number or letter set by the parent or guardian, the student is notified 204 via media such as without limitation a text message, electronic mail, or voice message that the student's actual grade is approaching the minimum grade set by the parent or guardian and that if the student's actual grade falls below the set minimum, the student will lose certain preselected and predetermined privileges. The notification 204 is provided to encourage the student to increase the actual grade, incentivizing the student by withholding privileges if the actual grade falls below the preselected and predetermined minimum threshold grade.

If the student's actual grade falls below the preselected and predetermined minimum threshold grade, student privileges are suspended 206. The parent or guardian predetermines and preselects the privileges suspended but can lift the suspension at any time via the user interface 106.

Those skilled in the art will appreciate the plethora of privileges that can be suspended by the enforcer 104. However FIG. 2 illustrates a select few privileges which can be suspended by the parent or guardian. The specified suspended privileges herein are provided for illustrative purposes only and are not intended to restrict or limit the embodiments of the present invention.

Student privilege suspensions comprise without limitation cellular phone service suspension 208, extra-curricular activity participation suspension 210, and credit or debit card service suspension 212. Cellular phone service suspension 208 includes without limitation suspension of voice services as well was text messaging services. Credit and/or debit card suspension 212 includes without limitation suspension of bank accounts, savings accounts, or the like as well as the use of debit or credit cards. Extra-curricular activity suspension 210 includes without limitation suspension of various school and/or non-school sponsored sports, games or other events. The enforcer 104 links to a school's student information systems API 110, thereby enabling the suspension of school-sponsored extra-curricular activities via the student's school identification card. Therefore if a student attempts to attend a school football game, the student would not be granted access thereto because the identification card information would include a restriction implemented by the enforcer 104.

One of ordinary skill in the art will appreciate that the present invention can be utilized in a reverse manner. A parent or guardian along with the corporation, organization, or other entity can employ the method and system of the present invention to provide incentives to a student to excel in academia and/or in other activities, even if the student is not in danger of failing a course. For example, a phone service provider can provide a student with a predetermined amount of free phone usage if the student maintains a certain grade number or letter. A credit/debit service provider can provide a student with a predetermined amount of free credit if the student maintains a certain grade number or letter. Therefore, organizations, such as corporations, can utilize the present invention to provide incentives to students while creating and building organizational goodwill.

The embodiments of the present invention apply to gradebook and attendance software, regardless of type or function, phone service providers, regardless of type or function, student information systems, regardless of type or function, credit or debit service providers, regardless of type or function, and APIs, regardless of type or function.

Although the embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method for transforming an under-achieving student into a superior student comprising the steps of:
Identifying an under-achieving student;
Identifying an academic counsel for the identified students;
Enrolling the identified student in the identified academic course;
Determining a minimum grade level for the identified student in the identified academic course;
Identifying a privilege for the identified student;
Initially providing the identified student with access to the identified privilege;
Continuously monitoring the identified student's performance in the identified academic course;
Automatically terminating the identified student's access to the identified privilege whenever the identified student's grade level in the identified academic course falls below the determine grade level.
